(19) United States
(12) Patent Application Publication
(10) Pub. No.: US 2015/0218474 A1
(43) Pub. Date: Aug. 6, 2015

(54) Fluid with Charged Carbon Particles and Method of Production

(71) Applicant: MAGNEGAS CORPORATION, Tarpon Springs, FL (US)

(72) Inventors: Christopher Lynch, Largo, FL (US); Scott Marton, Tarpon Springs, FL (US); Jack Michael Armstrong, Pinellas Park, FL (US); Ermanno Santilli, Clearwater, FL (US)

(73) Assignee: MAGNEGAS CORPORATION, Tarpon Springs, FL (US)

(21) Appl. No.: 14/613,729

(22) Filed: Feb. 4, 2015

Related U.S. Application Data
(60) Provisional application No. 61/936,072, filed on Feb. 5, 2014.

(51) Int. Cl. C10L 1/12; B01J 19/08; C10L 3/00

(52) U.S. Cl. CPC C10L 1/1208; C10L 3/003; B01J 19/088; C10L 2290/38; C10L 2250/06; C10L 2230/22; B01J 2219/0894; B01J 2219/0839

(57) ABSTRACT

A combustible fluid that includes sufficient suspended charged carbon particles or nanoparticles as to affect the burning characteristics of the combustible fluid that includes the suspended charged carbon particles or nanoparticles.

### CROSS-REFERENCE TO RELATED APPLICATION

This application claims the benefit of U.S. provisional application No. 61/936,072 filed on Feb. 5, 2014, the disclosure of which is incorporated by reference.

### FIELD

This invention relates to the field of combustible gases or liquids, and more particularly to a combustible gas including charged carbon particles.

### BACKGROUND

Various different combustible gases and liquids exist that are typically combusted to produce heat, electricity, to weld, to cut, etc. These gases and liquids (fluids) often lack suspended carbon and, therefore, the burn characteristics of these gases suffer.

What is needed is a combustible fluid containing suspended charged particles or nanoparticles.

### SUMMARY

In one embodiment, a combustible fluid is disclosed including sufficient suspended charged carbon particles or nanoparticles as to affect the burning characteristics of the combustible fluid that includes the charged carbon nanoparticles.

In another embodiment, a combustible fluid is disclosed including sufficient suspended ionically charged carbon particles or nanoparticles as to affect the burning characteristics of the combustible fluid that includes the charged suspended carbon particles or carbon nanoparticles.

In another embodiment, a combustible fluid is disclosed including sufficient magnetically charged suspended carbon particles or nanoparticles as to affect the burning characteristics of the combustible fluid that includes the charged carbon particles or nanoparticles.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system for the production of a fluid with charged carbon nanoparticles.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Nanoparticles are ultrafine particles typically between 1 and 100 nanometers in size. Throughout this specification, carbon particles or nanoparticles refers to particulate carbon that is between 1 and 100 nanometers (nanoparticles) or larger (particles) such as carbon soot or carbon molecule clusters. Carbon soot is often formed from carbon nanoparticles.

By bonding ionically or magnetically charged carbon particles or nanoparticles to a combustible gas or liquid (e.g. fluid), the burning properties of the fluid change. Any combustible fluid is anticipated including, but not limited to, hydrogen, syngas, propane, diesel, gasoline, kerosene. The inclusion of the now suspended charged carbon particles or nanoparticles changes the burning properties of the fluid in a productive manner. Such fluids with charged carbon particles or nanoparticles have improved burning characteristics as compared to the same fluid without suspended charged carbon particles or nanoparticles. The improvements to the combustible fluid include any or all of the following:
An increase in the energetic or caloric value of the fluid.
An increase in the flame temperature of the fluid.
An increase in the flame speed of the fluid.
Reduced emissions from the fluid when the fluid is used in combustion (e.g., pre-combustion, primary-combustion or secondary combustion.
Reduced emissions from the fluid when the fluid is co-combusted with hydrocarbons such as coal, oil, petroleum coke, etc.

In one example, a gas created by processing used vegetable oil with a plasma drawn between carbon electrodes has been shown to have a burn temperature of 8900 degrees F. while a similar gas absent of the carbon nanoparticles is expected to have a burn temperature of around 4500 degrees F.

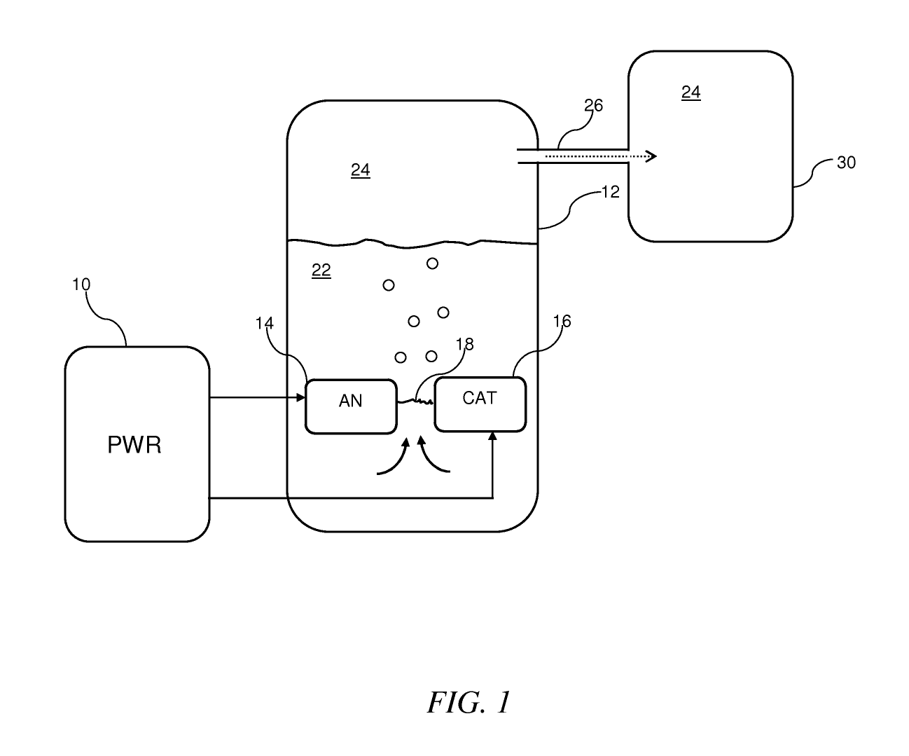

Referring to FIG. 1, an exemplary system for the production of a fluid with charged carbon particles or nanoparticles is shown. This is but an example of one system for the production of a fluid with charged carbon particles or nanoparticles, as other such systems are also anticipated achieving the same or similar results in alternate configurations. The production of a fluid with ionically or magnetically charged suspended carbon particles or nanoparticles is performed within the plasma 18 of an electric arc. A feedstock 22 is circulated within a reactor 12 and is injected into the plasma 18 of an electric arc between two electrodes 14/16, causing the feedstock 22 to react, depending upon the composition of the feedstock 22 and the electrodes 14/16 used to create the arc. By using at least one electrode 14/16 that comprises carbon, that electrode(s) 14/16 will release carbon molecules that, in the presence of the strong magnetic forces and high temperatures of the plasma 18, will form carbon nanoparticles. At the same time, the feedstock 22, bonding with carbon molecules, produces a gas 24 that is infused with some of these carbon nanoparticles. The infusion of the carbon nanoparticles results in a gas 24 that has different properties than a gas produced by other means from a similar or different feedstock.

In one example, if the feedstock 22 is water based (e.g. sewage, animal waste, manure, fish fecal matter) and the electrodes 14/16 are carbon, the water molecules separate within the plasma 18 of the electric arc into a gas 24 comprising hydrogen (H₂) and carbon monoxide (CO) atoms and carbon particles, which percolate to the surface of the water-based feedstock 22 for collection (e.g. extracted through a collection pipe 26. This gas 24, without the charged carbon particles or nanoparticles, is commonly known as synthetic natural gas or syngas, but the gas produced though the disclosed process behaves differently, having a higher burn temperature than syngas due to the carbon nanoparticles. Since at least one of the electrodes of the arc is made from carbon, that electrode becomes a source of the charged carbon particles or nanoparticles that become suspended within the manufactured hydrogen and carbon monoxide gas. The carbon particles or nanoparticles are collected along with the hydrogen and carbon monoxide gas, thereby changing the burning properties of the resulting gas 24.

Another example uses a hydrocarbon as the feedstock 22 (e.g. petroleum-based liquid feedstock). During the exposure of a hydrocarbon feedstock 22 to the arc (as above), polycyclic aromatic hydrocarbons are formed which are quasi-nanoparticles that are not stable and, therefore, some polycyclic aromatic hydrocarbons will form/join to become nanoparticles or a liquid. Therefore, some polycyclic aromatic hydrocarbons as well as some carbon particles/nanoparticles are present in the resulting gas. Some of the carbon particles or nanoparticles are trapped or enclosed in poly cyclic bonds. Analysis of the produced gas shows polycyclic aromatic hydrocarbons that range from C6 to C14. The presence of polycyclic aromatic hydrocarbons as well as carbon particles or nanoparticles contributes to the unique burn properties of the resulting gas 24.

When the feedstock 22 is petroleum based (e.g. used motor oil) and at least one of the electrodes 14/16 are carbon, the petroleum molecules separate within the plasma 18 of the electric arc into hydrogen (H₂) and aromatic hydrocarbons, which percolate to the surface of the petroleum liquid 22 for collection (e.g. extracted through a collection pipe 26. The gas produced though this process includes suspended carbon particles since at least one of the electrodes of the arc is made from carbon and serves as the source for the charged carbon particles or nanoparticles that travel with the manufactured hydrogen and aromatic hydrocarbon gas and are collected along with the hydrogen and aromatic hydrocarbon gas, thereby changing the burning properties of the resulting gas 24. In this example, if the feedstock 22 is oil (e.g. used oil), the fluid/gas collected includes hydrogen, ethylene, ethane, methane, acetylene, and other combustible gases to a lesser extent, plus suspended charged carbon particles or nanoparticles that travel with these gases 24.

Many feedstocks 22 are anticipated, including petroleum-based feedstocks 22 (e.g. oil, used motor oil, crude oil, diesel fuel, gasoline), water-based feedstocks (e.g. water, salt water, sewerage), plant-based oils (e.g., plant oils, used cooling oils), and animal-based oils (e.g., animal-based cooking oils, lard).

By including the carbon particles or nanoparticles in the resulting fluid, the burning characteristics of the manufactured fluid change. For example, using syngas for welding and cutting results in excess slag and poor or slow cutting properties, while using the gas 24 as produced above with suspended ionized or charged carbon particles or nanoparticles produces higher burn temperatures, resulting in better and faster cutting and greatly reduced slag.

In the exemplary reactor 12 of FIG. 1, the electrodes 14/16 are shown as an anode 14 and a cathode 16. An arc is formed between the electrodes after sufficient voltage potential and current is provided across the electrodes 14/16 by a source of power 10. In a preferred embodiment, the reactor 12 is sealed and the feedstock 22 is placed under pressure while the feedstock 22 is fed through the plasma 18 by a circulation system (not shown for clarity and brevity). This pressure being higher than air pressure at sea level (approximately 14.7 pounds per square inch or one atmosphere).

At some point, the gas 24 produced is extracted and stored in a holding tank 30 for later post-processing and distribution. For example, the gas 24 is compressed and stored in canisters that have various safety features.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A combustible fluid, the combustible fluid comprising:
hydrocarbons; and
suspended charged carbon particles.

2. The combustible fluid of claim 1, wherein the suspended charged carbon particles are charged carbon nanoparticles.

3. The combustible fluid of claim 1, wherein the suspended charged carbon particles are ionically charged.

4. The combustible fluid of claim 1, wherein the suspended charged carbon particles are magnetically charged.

5. The combustible fluid of claim 1, wherein the suspended charged carbon particles are trapped or enclosed in poly cyclic bonds.

6. The combustible fluid of claim 1, wherein the suspended charged carbon particles are electrically charged.

7. A method of producing a combustible fluid, the method comprising:
exposing a hydrocarbon-based liquid to a plasma within a reactor;
extracting a gas from the reactor, the gas comprising hydrocarbons plus suspended carbon particles, therefore, when burned, the gas burns at a higher temperature than a similar gas with a same hydrocarbon composition but lacking the carbon particles.

8. The method of claim 7, wherein the plasma is of an electric arc formed between two electrodes, wherein at least one of the two electrodes comprises carbon.

9. The method of claim 7, wherein the plasma is of an electric arc formed between two carbon electrodes.

10. The method of claim 7, wherein the reactor is sealed and the hydrocarbon liquid is under a pressure that is higher than air pressure at sea level.

11. The method of claim 7, wherein the suspended carbon particles are charged carbon nanoparticles.

12. The method of claim 11, wherein the suspended charged carbon nanoparticles are ionically charged.

13. The method of claim 11, wherein the suspended charged carbon nanoparticles are magnetically charged.

14. The method of claim 11, wherein the suspended charged carbon nanoparticles are electrically charged.

15. The method of claim 11, wherein the suspended charged carbon nanoparticles are trapped or enclosed in poly cyclic bonds.
